(19) United States
(12) Patent Application Publication
(10) Pub. No.: US 2024/0128775 A1
(43) Pub. Date: Apr. 18, 2024

(54) Charging/Discharging Circuit and Electronic Device

(71) Applicant: Honor Device Co., Ltd., Shenzhen (CN)

(72) Inventors: Yang Mao, Shenzhen (CN); Changying Zhang, Shenzhen (CN); Yupeng Qiu, Shenzhen (CN); Haibin Zhou, Shenzhen (CN); Tieli Zhang, Shenzhen (CN)

(21) Appl. No.: 18/246,248

(22) PCT Filed: Aug. 26, 2022
(86) PCT No.: PCT/CN2022/114989

§ 371 Date: Mar. 22, 2023

(30) Foreign Application Priority Data
Sep. 16, 2021 (CN) 202111085567.X
Nov. 17, 2021 (CN) 202111362926.1

(51) Int. Cl. H02J 7/00

(52) U.S. Cl. CPC H02J 7/0063; H02J 7/0019; H02J 7/0031; H02J 7/00714; H02J 7/007182

(57) ABSTRACT

A charging/discharging circuit and an electronic device. A first end of a first branch is connected to a voltage supply end, a second end thereof is connected to a first battery, and a voltage provided by the voltage supply end charges the first battery through the first branch; a first end of a second branch is connected to the voltage supply end, a second end thereof is connected to a second battery, and the voltage provided by the voltage supply end charges the second battery through the second branch; the second branch includes a first control circuit that is configured to adjust impedance of the second branch; and a processing module is configured to obtain a first current of the first branch and a second current of the second branch, and indicate, based on the first and second currents, the first control circuit to adjust impedance of the second branch.

### TECHNICAL FIELD

This application relates to the field of charging/discharging technologies, and in particular, to a charging/discharging circuit and an electronic device.

### BACKGROUND

To improve a battery life of an electronic device, a plurality of batteries may be provided in the electronic device. When the plurality of batteries are to be charged, a parallel charging solution may be used, that is, one charging branch is provided for each battery, and a plurality of charging branches are connected in parallel. However, in a current charging solution, the plurality of batteries cannot be fully charged simultaneously, which may lead to a problem that one battery is fully charged while the other batteries are not fully charged. Consequently, the other batteries cannot achieve maximum application efficiency.

### SUMMARY

This application provides a charging/discharging circuit and an electronic device, to balance charging speeds of a plurality of batteries, and improve application efficiency of the batteries.

According to a first aspect, an embodiment of this application provides a charging/discharging circuit, configured to charge/discharge a battery pack, where the battery pack includes a first battery and a second battery, and the circuit includes a processing module, a first branch, and a second branch;
a first end of the first branch is connected to a voltage supply end, a second end thereof is connected to the first battery, and a voltage output by the voltage supply end is used to charge the first battery through the first branch;
a first end of the second branch is connected to the voltage supply end, a second end thereof is connected to the second battery and the voltage output by the voltage supply end is used to charge the second battery through the second branch;
the second branch includes a first control circuit, and the first control circuit is configured to adjust impedance of the second branch; and
the processing module is configured to: obtain a first current of the first branch and a second current of the second branch; and indicate, based on the first current and the second current, the first control circuit to adjust the impedance of the second branch, so as to balance the first current and the second current.

When the battery pack is charged, the charging/discharging circuit can balance currents of the first branch and the second branch, thereby balancing charging speeds of a plurality of batteries, and improving application efficiency of the batteries.

In a possible implementation, the charging/discharging circuit further includes a charging management circuit, and a first end of the charging management circuit is used as a charging voltage supply end; and
the processing module is further configured to: obtain a first voltage of the first branch and a second voltage of the second branch, and when a difference between the first voltage and the second voltage is not greater than a preset first threshold, if it is detected that the second end of the first branch receives a charging voltage, control the first end of the charging management circuit to output a voltage.

In a possible implementation, the processing module is further configured to: when the difference between the first voltage and the second voltage is greater than the preset first threshold, if it is detected that the second end of the first branch receives the charging voltage, control the first end of the charging management circuit not to output the voltage.

In a possible implementation, the processing module is further configured to: when the difference between the first voltage and the second voltage is greater than the preset first threshold, indicate, based on the first current and the second current, the first control circuit to adjust the impedance of the second branch, so as to balance the first current and the second current.

In a possible implementation, the first branch includes a second control circuit, aiid the second control circuit is configured to adjust impedance of the second branch; and
the processing module is further configured to indicate, based on the first current and the second current, the second control circuit to adjust the impedance of the first branch, so as to balance the first current and the second current.

In a possible implementation, the processing module is specifically configured to:
when the first current is lower than the second current, and a difference between the first current and the second current is greater than a preset second threshold, if it is determined that the impedance of the first branch is greater than minimum impedance, indicate the second control circuit to reduce the impedance of the first branch; or if it is determined that the impedance of the first branch is the minimum impedance, indicate the first control circuit to increase the impedance of the second branch.

In a possible implementation, the processing module is specifically configured to:
when the first current is greater than the second current, and a difference between the first current and the second current is greater than a preset second threshold, if it is determined that the impedance of the second branch is greater than minimum impedance, indicate the first control circuit to reduce the impedance of the second branch; or if it is determined that the impedance of the second branch is the minimum impedance, indicate the second control circuit to increase the impedance of the first branch.

In a possible implementation, the second control circuit is further configured to: when an electronic device is in a powered-off state, control the first branch to be in a connected state.

In a possible implementation, the first control circuit is further configured to: when the electronic device is in the powered-off state, control the second branch to be in a disconnected state.

In a possible implementation, the processing module is further configured to:
when the first battery and the second battery discharge, indicate the first control circuit to adjust the impedance of the second branch to minimum impedance, and indicate the second control circuit to adjust the impedance of the first branch to the minimum impedance.

In a possible implementation, the first control circuit includes a first switching transistor with a linear interval;
a first end and a second end of the first switching transistor are respectively used as the first end and the second end of the second branch, and a control end thereof is connected to the processing module; and
the processing module is specifically configured to: send a control signal to the control end of the first switching transistor, to control impedance and connection/disconnection of the first switching transistor.

In a possible implementation, the first control circuit includes a second switching transistor with a linear interval, a third switching transistor with a linear interval, and a first resistor;
a first end and a second end of the second switching transistor are respectively used as the first end and the second end of the second branch, a control end of the second switching transistor is grounded through the third switching transistor, a control end of the third switching transistor is connected to the processing module, and the second end of the second switching transistor is connected to the control end of the first switching transistor through the first resistor; and
the processing module is specifically configured to: send a control signal to the control end of the third switching transistor, to control impedance and connection/disconnection of the third switching transistor.

In a possible implementation, the control signal sent by the processing module is a PWM signal, and the first control circuit further includes a first voltage control circuit;
that a control end of the third switching transistor is connected to the processing module includes: the control end of the third switching transistor is connected to the processing module through the first voltage control circuit; and
the first voltage control circuit is configured to: convert the PWM signal sent by the processing module into a direct current control signal; and send the converted direct current control signal to the control end of the third switching transistor.

In a possible implementation, the second control circuit includes a fourth switching transistor with a linear interval;
a first end and a second end of the fourth switching transistor are respectively used as the first end and the second end of the first branch, and a control end thereof is connected to the processing module; and
the processing module is configured to send a control signal to the control end of the fourth switching transistor, to control impedance and connection/disconnection of the fourth switching transistor.

In a possible implementation, the second control circuit includes a fifth switching transistor with a linear interval, a sixth switching transistor with a linear interval, and a second resistor:
a first end and a second end of the fifth switching transistor are respectively used as the first end and the second end of the first branch, a control end of the fifth switching transistor is grounded through the sixth switching transistor, and a control end of the sixth switching transistor is connected to the processing module; and
the processing module is configured to send a control signal to the control end of the sixth switching transistor, to control impedance and connection/disconnection of the fourth switching transistor.

In a possible implementation, the control signal sent by the processing module is a PWM signal, and the second control circuit further includes a second voltage control circuit;
that a control end of the sixth switching transistor is connected to the processing module includes: the control end of the sixth switching transistor is connected to the processing module through the second voltage control circuit; and
the second voltage control circuit is configured to: convert the control signal sent by the processing module into a direct current voltage signal, and send the converted direct current control signal to the control end of the third switching transistor.

In a possible implementation, the charging/discharging circuit further includes a collection circuit, and the collection circuit is connected to both the battery pack and the processing module;
the collection circuit is configured to collect currents and/or voltages of the first branch and the second branch, and send the collected currents and/or voltages to the processing module; and
the processing module is further configured to receive the currents and/or voltages.

According to a second aspect, an embodiment of this application provides an electronic device, including a battery pack and the charging/discharging circuit according to any one of the first aspect, where the charging/discharging circuit is configured to charge/discharge a battery in the battery pack.

### BRIEF DESCRIPTION OF DRAWINGS

To describe technical solutions in embodiments of the present invention more clearly, the following briefly describes accompanying drawings required for describing embodiments. Apparently, the accompanying drawings in the following description show only some embodiments of the present invention, and a person of ordinary skill in the art may still derive other drawings from these accompanying drawings without creative efforts.

FIG. 1 is a schematic diagram of a structure of a charging/discharging circuit in a scenario according to this application;

FIG. 2 is a schematic diagram of an operating principle of a charging/discharging circuit in the scenario shown in FIG. 1 according to this application;

FIG. 3 is a schematic diagram of an operating principle of a charging/discharging circuit in the scenario shown in FIG. 1 according to this application;

FIG. 4 is a schematic diagram of an operating principle of a charging/discharaing circuit in the scenario shown in FIG. 1 according to this application;

FIG. 5 is a schematic diagram of an operating principle of a charging/discharaing circuit in the scenario shown in FIG. 1 according to this application;

FIG. 6 is a schematic diagram of an operating principle of a charging/discharging circuit in the scenario shown in FIG. 1 according to this application;

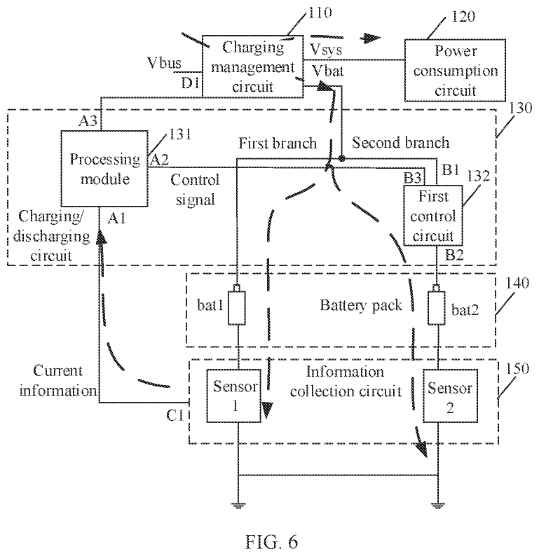

FIG. 7A is a schematic diagram of an implementation structure of a charging/discharging circuit in the scenario shown in FIG. 1 according to this application;

FIG. 7B is a schematic diagram of an implementation structure of a charging/discharging circuit in the scenario shown in FIG. 1 according to this application;

FIG. 8A is a schematic diagram of an implementation structure of a charging/discharging circuit in the scenario shown in FIG. 1 according to this application;

FIG. 8B is a schematic diagram of an implementation structure of a charging/discharging circuit in the scenario shown in FIG. 1 according to this application;

FIG. 9 is a schematic diagram of a structure of a charging/discharging circuit in another scenario according to this application;

FIG. 10 is a schematic diagram of an operating principle of a charging/discharging circuit in the scenario shown in FIG. 9 according to this application;

FIG. 11 is a schematic diagram of an operating principle of a charging/discharging circuit in the scenario shown in FIG. 9 according to this application;

FIG. 12 is a schematic diagram of an operating principle of a charging/discharging circuit in the scenario shown in FIG. 9 according to this application;

FIG. 13 is a schematic diagram of an operating principle of a charging; discharging circuit in the scenario shown in FIG. 9 according to this application;

FIG. 14 is a schematic diagram of an operating principle of a charging/discharging circuit in the scenario shown in FIG. 9 according to this application;

FIG. 15 is a schematic diagram of an implementation structure of a charging/discharging circuit in the scenario shown in FIG. 9 according to this application;

FIG. 16 is a schematic diagram of an implementation structure of a charging/discharging circuit in the scenario shown in FIG. 9 according to this application;

FIG. 17 is a schematic diagram of an implementation structure of a charging/discharging circuit in the scenario shown in FIG. 9 according to this application;

FIG. 18 is a schematic diagram of an implementation structure of a charging/discharging circuit in the scenario shown in FIG. 9 according to this application;

FIG. 19 is a schematic diagram of an implementation structure of a charging/discharging circuit in the scenario shown in FIG. 9 according to this application;

FIG. 20 is a schematic diagram of an operating principle of the circuit shown in FIG. 19; and

FIG. 21 is a schematic diagram of an operating principle of the circuit shown in FIG. 19.

### DESCRIPTION OF EMBODIMENTS

Terms used in implementations of this application are only used to explain specific embodiments of this application, and are not intended to limit this application.

In an existing multi-battery parallel charging solution, after a charging branch of each battery is determined, impedance of the charging branch is fixed. Due to design influence of wiring, an architecture, and the like of the charging branch, impedance of a plurality of charging branches cannot be consistent. This causes that charging currents of the plurality of batteries cannot be equal during charging, the plurality of batteries cannot be fully charged simultaneously, which may lead to a problem that one battery is fully charged while the other batteries are not fully charged. Consequently, the other batteries cannot achieve maximum application efficiency.

Therefore, this application provides a charging/discharging circuit and an electronic device, so as to reduce a probability that batteries cannot be fully charged simultaneously during multi-battery parallel charging, and improve application efficiency of the batteries.

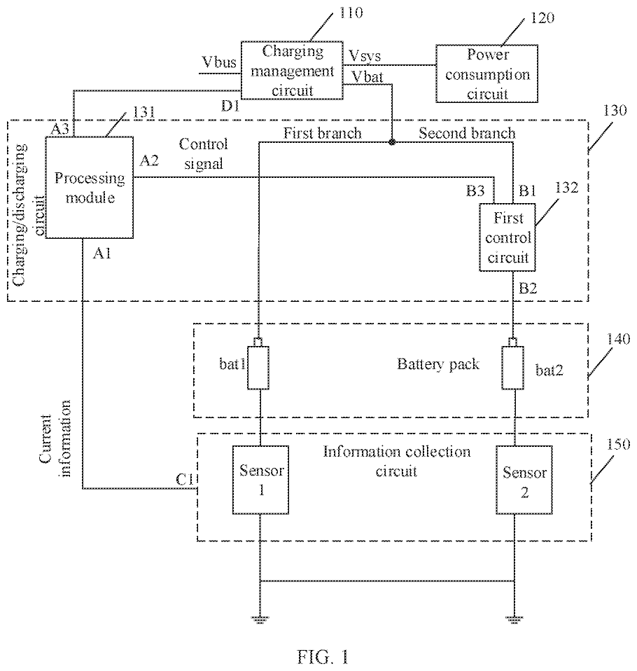

FIG. 1 is a schematic diagram of an applicable scenario of a charging/discharging circuit according to an embodiment of this application. As shown in FIG. 1, the scenario includes a charging management circuit 110, a power consumption circuit 120, a charging/discharging circuit 130, a battery pack 140, and an information collection circuit 150.

The battery pack 140 includes a first battery MO and a second battery batt.

The charging/discharging circuit 130 includes a processing module 131, a first branch, and a second branch. The second branch includes a first control circuit 132, and the first control circuit 132 is configured to adjust impedance of the second branch and control a connected/disconnected state of the second branch.

A Vbus terminal of the charging management circuit 110 is configured to: connect to a charging voltage pin of a charging interface of an electronic device; for example, if the charging interface is a type-c interface, a charging voltage end may be a Vbus pin of the type-c interface, which receives a power supply voltage provided by a charger side. A Vsys terminal of the charging management circuit 110 is connected to the power consumption circuit 120 in the electronic device, to provide a system voltage for the power consumption circuit 120 in the electronic device. A D1 end of the charging management circuit 110 is connected to an A3 end of the processing module 131 in the charging/discharging circuit. A Vbat terminal of the charging management circuit 110 is connected to both a first end of the first branch and a first end of the second branch in the charging/discharging circuit 130. The charging management circuit 110 is configured to manage a transmission line between the Vbus terminal and the Vbat terminal, a transmission line between the Vbus terminal and the Vsys terminal, and a transmission line between the Vbat terminal and the Vsys terminal.

A second end of the first branch is connected to a positive electrode of the first battery bat1. A second end of the second branch is connected to a positive electrode of the second battery bat2.

A negative electrode of the first battery MO is grounded through a sensor 1 in the information collection circuit 150, and the sensor 1 is configured to collect a current and/or a voltage of a line on which the first battery bat1 is located. A negative electrode of the second battery bat2 is grounded through a sensor 2 in the information collection circuit 150, and the sensor 2 is configured to collect a current and/or a voltage of a line on which the second battery batt is located.

The first control circuit 132 is provided in the second branch. Specifically, a B1 end of the first control circuit 132 is connected to the first end of the second branch, a B2 end thereof is connected to the second end of the second branch, and a B3 end thereof is connected to an A2 end of the processing module 131.

A C1 end of the information collection circuit 150 is connected to an A1 end of the processing module 131, to transmit a current and/or a voltage collected by the information collection circuit 150 to the processing module 131.

A circuit implementation in each scenario is described based on the foregoing circuit structure.

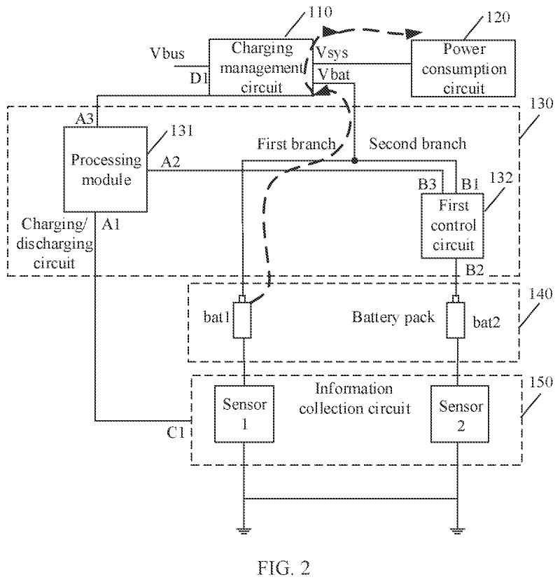

When the electronic device is not powered on, as shown in FIG. 2, a path is formed between the first battery batt and the power consumption circuit 120 in the electronic device through the first branch and the charging management circuit 110, If the electronic device is powered on, the first battery ball supplies power to the power consumption circuit 120 through the first branch and the charging management circuit 110, so that the electronic device can be powered on and operates normally.

Optionally, the first control circuit 132 may be configured to: when the electronic device is not powered on, control the second branch to be disconnected, so that the first battery ball is isolated from the second battery bat2. In this case, when the electronic device is powered on, only the first battery bat1 supplies power to the power consumption circuit 120.

After the electronic device is powered on, the processing module 131 starts to power on and operates. In this case, the processing module 131 may indicate the first control circuit 132 to continue to control the second branch to remain in a disconnected state.

The information collection circuit 150 may be configured to separately sample voltages and currents of lines on which the first battery and the second battery are located, and send the sampled voltages (a first voltage and a second voltage) and the sampled currents (a first current and a second current) to the processing module 131, Optionally, the first voltage may be a voltage of the positive electrode of the first battery batt, and the second voltage may be a voltage of the positive electrode of the second battery bat2.

Processing of the processing module 131 is divided into the following two scenarios:

Case 1: The Vbus terminal of the charging management circuit 110 does not receive a charging voltage, that is, the electronic device is not connected to the charger to charge the battery. In this case, the battery pack supplies power to the power consumption circuit 120.

The processing module 131 is configured to: when −Vth_open≤V1−V2≤Vth_open, indicate the first control circuit 132 to control the second branch to be connected. Optionally, the processing module 131 may further indicate the first control circuit 132 to adjust the impedance of the second branch to minimum impedance, so as to minimize power consumption of the second branch. V1 is the first voltage, V2 is the second voltage, and Vth_open is a preset threshold.

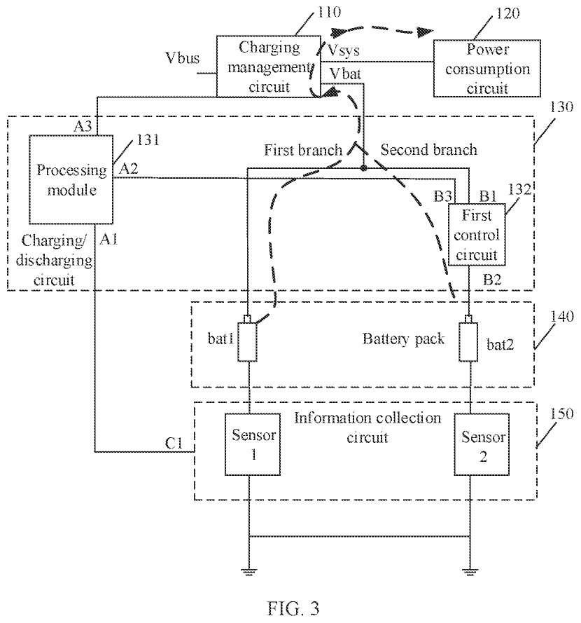

In this case, as shown in FIG. 3, the first battery bat1 and the second battery bat2 supply power to the power consumption circuit 120 simultaneously through the charging management circuit 110.

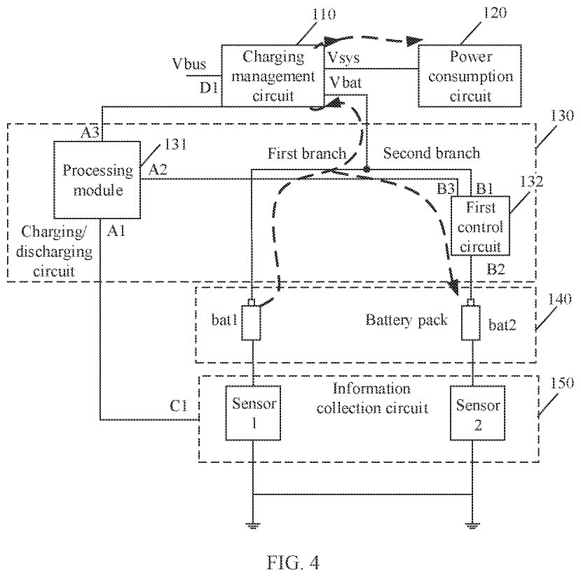

The processing module 131 is configured to: when V1−V2>Vth_open, indicate the first control circuit 132 to control the second branch to be connected, and indicate, based on the first current and the second current, the first control circuit 132 to adjust the impedance of the second branch, so as to enable a difference between the first current and the second current to be not greater than a threshold Ith_balance. In this case, as shown in FIG. 4, the first battery bat1 supplies power to the power consumption circuit 120, and charges the second battery bat2. In addition, the impedance of the second branch is adjusted, to ensure balance between the current of the first branch and the current of the second branch.

The processing module 131 is configured to: when V2−V1>Vth_open, indicate the first control circuit 132 to control the second branch to be connected, and indicate, based on the first current and the second current, the first control circuit 132 to adjust the impedance of the second branch, so as to enable a difference between the first current and the second current to be not greater than a threshold Ith_balance. In this case, the second battery bat2 supplies power to the power consumption circuit 120, and charges the first battery batt. In addition, the impedance of the second branch is adjusted, to ensure balance between the current of the first branch and the current of the second branch.

Optionally, that the processing module 131 indicates, based on the first current and the second current, the first control circuit 132 to adjust the impedance of the second branch may specifically include:

When I1−I2>Ith_balance, the processing module 131 indicates the first control circuit 132 to reduce the impedance of the second branch; or when I2−I1>Ith_halance, the processing module 131 indicates the first control circuit 132 to increase the impedance of the second branch; or when |I1−I2|≤Ith_balance, the processing module 131 indicates the first control circuit 132 to keep the impedance of the second branch unchanged. I1 is the first current, I2 is the second current, and Ith_balance is a preset threshold.

When V1−V2>Vth_open or V2−V1>Vth_open, power of the first battery bat1 and power of the second battery batt can be balanced based on the foregoing processing. For example, if a battery in the battery pack is replaced, or there is a large voltage difference between two batteries due to another reason, the power of the first battery bat1 and the power of the second battery bat2 can be balanced based on the foregoing processing.

Case 2: The V bus terminal of the charging management circuit 110 receives a charging voltage, that is, the electronic device connects to the charger to charge the battery. In this case, the charging voltage received by the Vbus terminal supplies power to the power consumption circuit 120.

The processing module 131 is configured to: when |V1−V2>Vth_open, if it is detected that the Vbus terminal of the charging management circuit 110 receives the charging voltage, control the charging management circuit 110 to connect a path between the Vbus terminal and the Vsys terminal, disconnect a path between the Vbus terminal and the Vbat terminal, and disconnect a path between the Vbus terminal and the Vsys terminal (that is, the Vbat terminal does not output a voltage, and the battery pack does not supply power to the power consumption circuit 120 through the Vbat terminal); and indicate the first control circuit 132 to control the second branch to be connected.

In this case, the charging management circuit 110 may be configured to: generate the system voltage based on the charging voltage received by the Vbus terminal, output the system voltage at the Vsys terminal to supply power to the power consumption circuit 120, disconnect the path between the Vbus terminal and the Vbat terminal, and disconnect the path between the Vbus terminal and the Vsys terminal.

Optionally, the processing module 131 may be configured to indicate the first control circuit 132 to adjust the impedance of the second branch to minimum impedance, so as to minimize power consumption of the second branch.

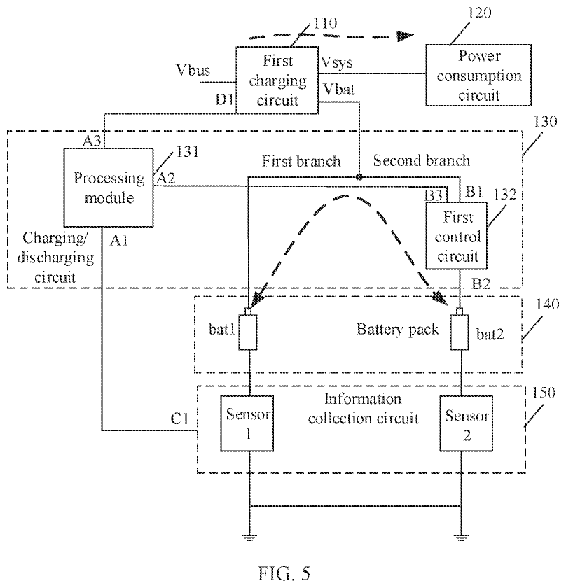

In this case, as shown in FIG. 5, the charging voltage received by the Vbus terminal of the charging management circuit 110 supplies power to the power consumption circuit 120; and a battery with a high voltage charges a battery with a low voltage between the first battery bat1 and the second battery bat2.

The processing module 131 is configured to: when −Vth_open≤V1−V2≤Vth_open, if it is detected that the Vbus terminal of the charging management circuit 110 receives the charging voltage, control the charging management circuit 110 to connect a path between the Vbus terminal and the Vsys terminal and connect a path between the Vbus terminal and the Vbat terminal; and indicate the first control circuit 132 to control the second branch to be connected. Optionally, the processing module 131 may further indicate the first control circuit 132 to adjust the impedance of the second branch to minimum impedance, so as to minimize power consumption of the second branch.

In this case, the charging management circuit 110 may be configured to: generate the system voltage based on the charging voltage received by the Vbus terminal, output the system voltage at the Vsys terminal to supply power to the power consumption circuit 120, generate a voltage for charging the battery pack based on the charging voltage received by the Vbus terminal, and output the voltage at the Vbat terminal to charge the first battery bat1 and the second battery bat2.

In this case, as shown in 6, the charging voltage received by the Vbus terminal of the charging management circuit 110 is used to supply power to the power consumption circuit 120 through the Vsys terminal; and the charging voltage received by the Vbus terminal of the charging management circuit 110 is used to charge the first battery bat1 and the second battery bat2 through the Vbat terminal.

In a process of charging the first battery bat1 and the second battery bat2, the processing module may be specifically configured to:
when I1−I2>Ith_charge, indicate the first control circuit 132 to reduce the impedance of the second branch; or when I2−I1>Ith_charge, indicate the first control circuit 132 to increase the impedance of the second branch; or when |I1−I2≤Ith_charge, indicate the first control circuit 132 to keep the impedance of the second branch unchanged.

Vth_open represents a preset threshold of the voltage difference, and Ith_charge and Ith_balance each represents a preset threshold of a current difference. A specific value of the threshold is not limited in this embodiment of this application. Values of Ith_charge and Ith_balance may be the same or different.

For case 2, when |V1−V2|>Vth_open, no voltage is output at the Vbat terminal of the charging management module for charging the first battery and the second battery, but the power of the first battery bat1 and the power of the second battery bat2 are first balanced. After |V1−V2|≤Vth_open, a voltage is output at the Vbat terminal of the charging management module for charging the first battery and the second battery. Therefore, based on the foregoing processing, the power of the first battery MO and the power of the second battery batt can be balanced in the process of charging, thereby improving application efficiency of the batteries.

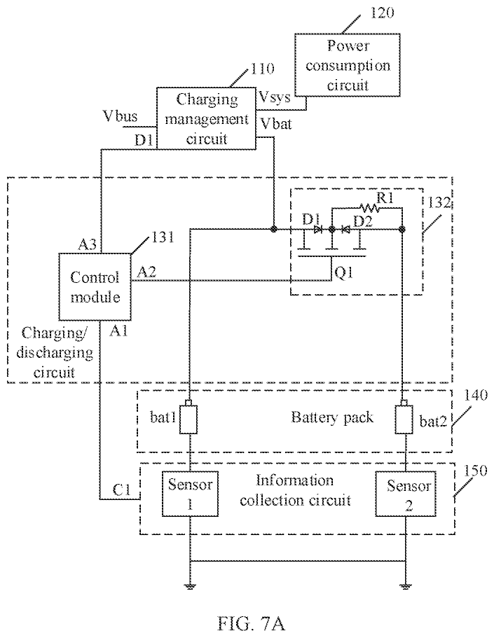

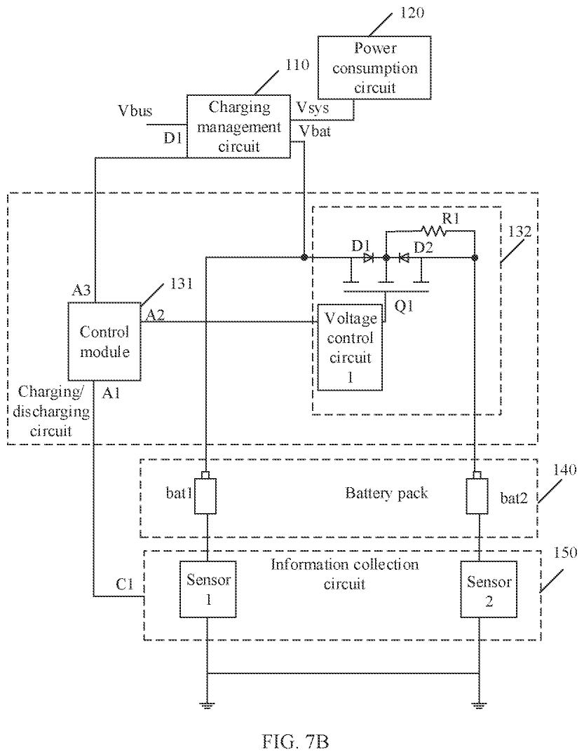

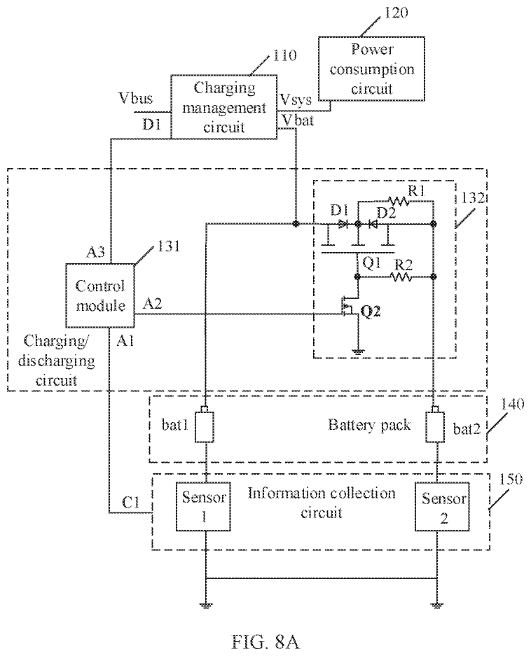

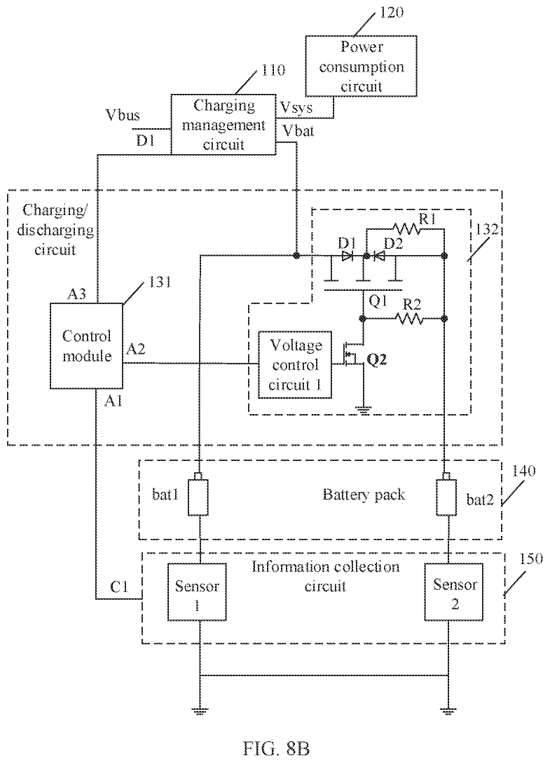

With reference to FIG. 7A to FIG. 8B, the following describes an implementation structure of the first control circuit 132 in the charging; discharging circuit as an example.

In a possible implementation, the first control circuit 132 may be implemented by using a switching transistor with a linear interval, for example, a metal-oxide-semiconductor field-effect transistor (Metal-Oxide-Semiconductor Field-Effect Transistor, MOSFET), a junction field-effect transistor (Junction Field-Effect Transistor, JFET), or a triode.

As shown in FIG. 7A, for example, the first control circuit 132 is implemented by using a bidirectional cut-off MOS transistor. A first end of a bidirectional cut-off MOS transistor Q1 is used as a first end B1 of the first control circuit 132, a second end of the bidirectional cut-off MOS transistor Q1 is used as a second end B2 of the first control circuit 132, and a gate thereof is used as a third end B3 of the first control circuit 132. To ensure normal operation of the bidirectional cut-off MOS transistor Q1, a fourth end of the bidirectional cut-off MOS transistor Q1 is connected to the second end by using a resistor R1. A diode D1 and a diode D2 are body diodes of the bidirectional cut-off MOS transistor Q1.

The processing module 131 may control the bidirectional cut-off MOS transistor Q1 to be connected or disconnected by outputting different direct current voltage signals to the gate of the bidirectional cut-off MOS transistor Q1, so as to control the second branch to be connected or disconnected. Because the bidirectional cut-off MOS transistor Q1 has a linear interval, namely, a variable resistance interval, the processing module 131 may control the bidirectional cut-off MOS transistor Q1 to operate in the linear interval by changing a magnitude of a direct current voltage signal output to the gate of the bidirectional cut-off MOS transistor Q1, and control impedance of the bidirectional cut-off MOS transistor Q1 to increase or decrease, thereby increasing or decreasing the impedance of the second branch. When the processing module 131 controls the bidirectional cut-off MOS transistor Q1 to be completely connected, the bidirectional cut-off MOS transistor Q1 has minimum impedance. Specifically, when the processing module 131 controls the bidirectional cut-off MOS transistor Q1 to be in the linear interval, if a voltage signal output by the processing module 131 through the A2 end is enhanced, the impedance of the bidirectional cut-off MOS transistor Q1 is increased, and the impedance of the second branch is increased; or if a voltage signal output by the processing module 131 through the A2 end is weakened, the impedance of the bidirectional cut-off MOS transistor Q1 is decreased, and the impedance of the second branch is decreased.

When the first control circuit 132 is implemented by using the bidirectional cut-off MOS transistor, for an operating principle of the circuit, refer to the foregoing description. Details are not described herein again.

Optionally, the processing module 131 may also output a PWM signal at the A2 end as a control signal of the bidirectional cut-off MOS transistor Q1. In this case, as shown in FIG. 7B, a voltage control circuit 1 is added between the A2 end of the processing module 131 and the gate of the bidirectional cut-off MOS transistor Q1, and the voltage control circuit 1 is configured to convert the PWM signal into a direct current voltage signal. The processing module 131 may adjust, by changing a duty cycle of the PWM signal, a voltage value of the direct current voltage signal obtained by converting by the voltage control circuit 1, to control the bidirectional cut-off MOS transistor Q1 to be completely connected, disconnected, in the linear interval, or the like.

In another possible implementation, as shown in FIG. 8A, the first control circuit 132 may include: A first end and a second end of a bidirectional cut-off MOS transistor Q1 are respectively used as a first end and a second end of the second branch, and a gate thereof is grounded through an NMOS transistor Q2; a control end of the NMOS transistor Q2 is connected to the processing module; and the second end of the bidirectional cut-off MOS transistor Q1 is connected to a control end of the bidirectional cut-off MOS transistor Q1 by using a resistor R2.

The processing module 131 may send a direct current voltage signal to the control end of the NMOS transistor Q2 as a control signal, to control impedance and connection/disconnection of the NMOS transistor Q2, so as to control impedance and connection/disconnection of the bidirectional cut-off MOS transistor Q1.

In this circuit structure, when the NMOS transistor Q2 is disconnected, a gate voltage of the bidirectional cut-off MOS transistor Q1 is 0, and the bidirectional cut-off MOS transistor Q1 is disconnected. When the NMOS transistor Q2 is completely connected or is in a linear interval, impedance of the resistor R2 and the impedance of the NMOS transistor Q2 divides a voltage of the second battery bat2, and the gate of the bidirectional cut-off MOS transistor Q1 receives a divided voltage. A change of the impedance of the NMOS transistor Q2 causes a change of the gate voltage of the bidirectional cut-off MOS transistor Q1; that is, the divided voltage received by the gate of the bidirectional cut-off MOS transistor Q1 changes, to control the bidirectional cut-off MOS transistor Q1 to be completely connected or in the linear interval. In addition, when the bidirectional cut-off MOS transistor Q1 is in the linear interval, a change of the divided voltage may cause the change of the impedance of the bidirectional cut-off MOS transistor Q1, and then cause a change of the impedance of the second branch. When the bidirectional cut-off MOS transistor Q1 is completely connected, the bidirectional cut-off MOS transistor Q1 has minimum impedance, and the second branch has minimum impedance.

Similar to FIG. 7B, the processing module 131 may output a PWM signal to the gate of the NMOS transistor Q2 at the A2 end. In this case, as shown in FIG. 8B, a voltage control circuit 1 may be added between the A2 end of the processing module 131 and the gate of the NMOS transistor Q2, to convert the PWM signal into the direct current voltage signal.

It may be understood that when no first control circuit is provided in the second branch of the foregoing circuit, the impedance of the branch is usually lower than the impedance of the first branch. That is, in a specific implementation, due to a limitation of an architecture or the like, the second battery may be relatively close to the Vbat terminal of the charging management circuit, and the first battery may be relatively far away from the Vbat terminal of the charging management circuit. In this case, wiring of the second branch circuit is relatively short and wiring of the first branch circuit is relatively long. In this case, when no first control circuit is provided, the impedance of the second branch circuit is lower than the impedance of the first branch circuit. By disposing the first control circuit, the impedance of the second branch circuit is adjusted and changed, so that the first current and the second current are close to each other during charging, it takes similar time to fully charge the first battery and the second batter, thereby improving application efficiency of the batteries.

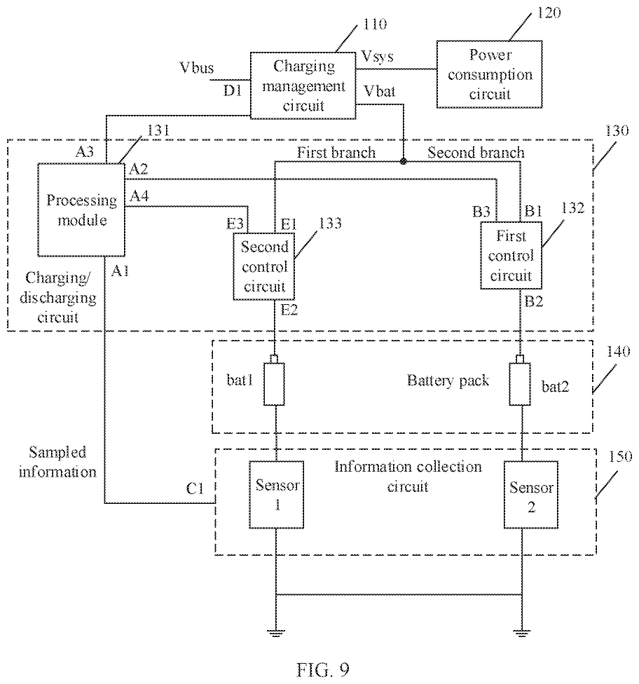

FIG. 9 is a schematic diagram of a structure of a charging/discharging circuit in another embodiment according to this application. As shown in FIG. 9, a second control circuit 133 is provided in the first branch relative to the charging/discharging circuit shown in FIG. 1. Specifically:

An E1 end of the second control circuit 133 is used as a first end of the first branch, an E2 end thereof is used as a second end of the first branch, and an E3 end thereof is connected to the A4 end of the processing module 131.

A circuit operating principle in each scenario is described based on the circuit structure shown in FIG. 9.

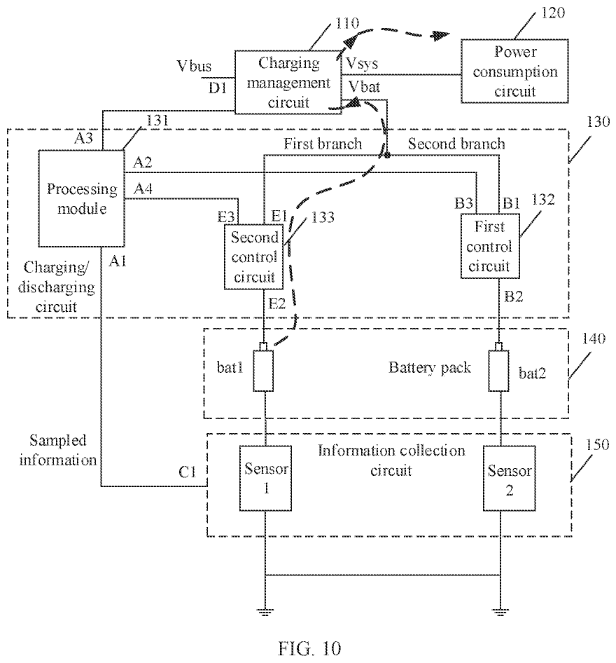

When the electronic device is not powered on, the second control circuit 133 may be configured to: when the electronic device is not powered on, control the first branch to be connected. As shown in FIG. 10, a path is formed between the first battery bat1 and the power consumption circuit 120 through the first branch and the charging management circuit 110. If the electronic device is to be powered on, the first battery batt supplies power to the power consumption circuit 120 in the electronic device through the first branch and the charging management circuit 110, so that the electronic device can be powered on and operates normally.

Optionally, the first control circuit 132 may be configured to: when the electronic device is not powered on, control the second branch to be disconnected, so that the first battery bat1 is isolated from the second battery batt. In this case, when the electronic device is powered on, only the first battery bat1 supplies power to the power consumption circuit 120.

After the electronic device is powered on, the processing module 131 starts to power on and operates. In this case, to isolate the first battery bad and the second battery batt, the processing module 131 may indicate the first control circuit 132 to continue to control the second branch to remain in a disconnected state.

The information collection circuit 150 may be configured to separately sample voltages and currents of lines on which the first battery and the second battery are located, and send the sampled voltages (a first voltage and a second voltage) and the sampled currents (a first current and a second current) to the processing module 131. Optionally, the first voltage may be a voltage of the positive electrode of the first battery ball, and the second voltage may be a voltage of the positive electrode of the second battery batt.

Processing of the processing module 131 is divided into the following two scenarios:

Case 1: The Vbus terminal of the charging management circuit 110 does not receive a charging voltage, that is, the electronic device is not connected to the charger to charge the battery. In this case, the battery pack supplies power to the power consumption circuit 120.

The processing module 131 is configured to: when −Vth_open≤V1−V2≤Vth_open, indicate the second control circuit 133 to control the first branch to be connected, and indicate the first control circuit 132 to control the second branch to be connected. Optionally, the processing module 131 may further indicate the first control circuit 132 to adjust the impedance of the second branch to minimum impedance, so as to minimize power consumption of the second branch. Optionally, the processing module 131 may be configured to indicate the second control circuit 133 to adjust impedance of the first branch to minimum impedance, so as to minimize power consumption of the first branch.

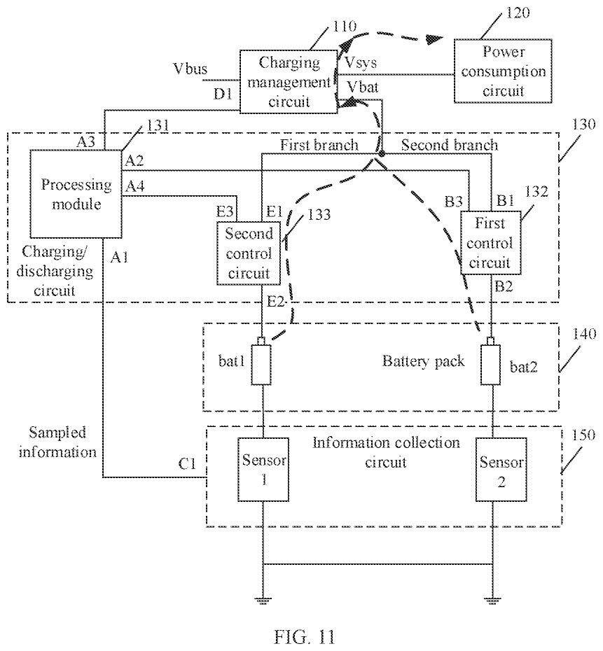

In this case, as shown in FIG. 11, the first battery ball and the second battery bat2 supply power to the power consumption circuit 120 simultaneously through the charging management circuit 110.

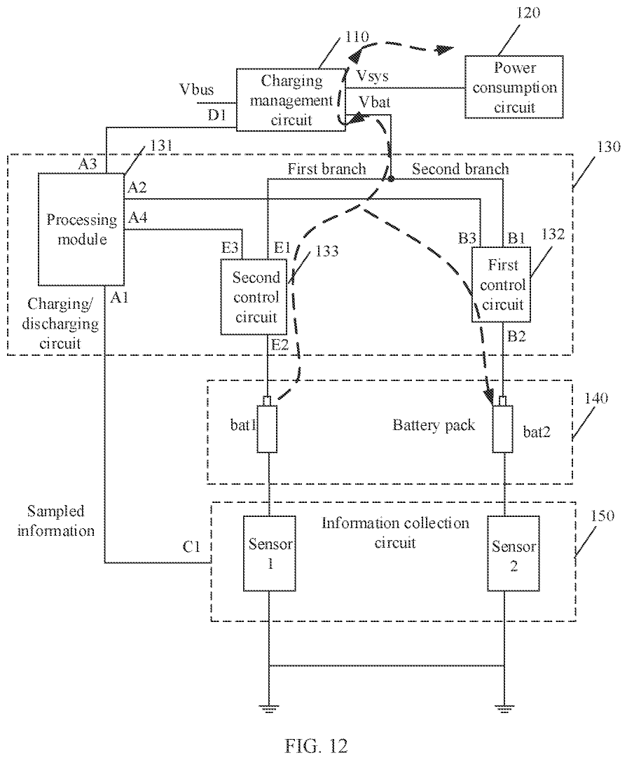

The processing module 131 is configured to: when V1−V2>Vth_open, indicate, based on the first current and the second current, the first control circuit 132 to adjust the impedance of the second branch, so as to enable a difference between the first current and the second current to be not greater than a threshold Ith_balance. In this case, as shown in FIG. 12, the first battery bat1 supplies power to the power consumption circuit 120, and charges the second battery bat2. In addition, the impedance of the second branch is adjusted, to ensure balance between the current of the first branch and the current of the second branch.

The processing module 131 is configured to: when V2−V1>Vth_open, indicate, based on the first current and the second current, the first control circuit 132 to adjust the impedance of the second branch, so as to enable a difference between the first current and the second current to be not greater than a threshold Ith_balance. In this case, the second battery bat2 supplies power to the power consumption circuit 120, and charges the first battery bat1. In addition, the impedance of the second branch is adjusted, to ensure balance between the current of the first branch and the current of the second branch.

Optionally, that the processing module 131 indicates, based on the first current and the second current, the first control circuit 132 to adjust the impedance of the second branch may specifically include:
when I1−I2>Ith_balance, indicating the first control circuit 132 to reduce the impedance of the second branch; or when I2−I1>Ith_balance, indicating the first control circuit 132 to increase the impedance of the second branch; or when I1−I2|≤Ith_balance, indicating the first control circuit 132 to keep the impedance of the second branch unchanged.

When V1−V2>Vth_open or V2−V1>Vth_open, power of the first battery bat1 and power of the second battery batt can be balanced based on the foregoing processing. For example, if a battery in the battery pack is replaced, or there is a large voltage difference between two batteries due to another reason, the power of the first battery ball and the power of the second battery bat2 can be balanced based on the foregoing processing.

Case 2: The Vbus terminal of the charging management circuit 110 receives a charging voltage, that is, the electronic device connects to the charger to charge the battery. In this case, the charging voltage received by the Vbus terminal supplies power to the power consumption circuit 120.

The processing module 131 is configured to: when |V1−V2|>Vth_open, if it is detected that the Vbus terminal of the charging management circuit 110 receives the charging voltage, control the charging management circuit 110 to connect a path between the Vbus terminal and the Vsys terminal, disconnect a path between the Vbus terminal and the Vbat terminal, and disconnect a path between the Vbus terminal and the Vsys terminal (that is, the Vbat terminal does not output a voltage, and the battery pack does not supply power to the power consumption circuit 120 through the Vbat terminal); and indicate the first control circuit 132 to control the second branch to be connected, and indicate the second control circuit 133 to control the first branch to be connected.

Optionally, the processing module 131 may be configured to indicate the second control circuit 133 to adjust the impedance of the first branch to minimum impedance, so as to minimize power consumption of the first branch. Optionally, the processing module 131 may be configured to indicate the first control circuit 132 to adjust the impedance of the second branch to minimum impedance, so as to minimize power consumption of the second branch.

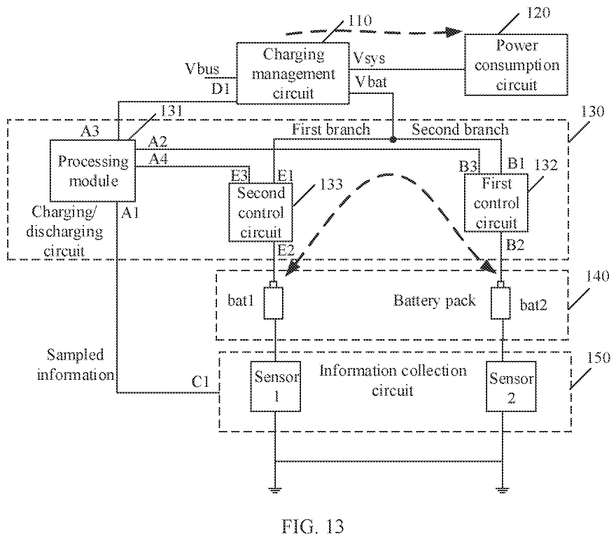

In this case, as shown in FIG. 13, the charging voltage received by the Vbus terminal of the charging management circuit 110 supplies power to the power consumption circuit 120; and a battery with a high voltage charges a battery with a low voltage between the first battery bat1 and the second battery batt.

The processing module 131 is configured to: when −Vth_open≤V1−V2≤Vth_open, if it is detected that the Vbus terminal of the charging management circuit 110 receives the charging voltage, control the charging management circuit 110 to connect a path between the Vbus terminal and the Vsys terminal and connect a path between the Vbus terminal and the Vbat terminal, and indicate the first control circuit 132 to control the second branch to be connected, and indicate the second control circuit 133 to control the first branch to be connected. Optionally, the processing module 131 may further indicate the first control circuit 132 to adjust the impedance of the second branch to minimum impedance, so as to minimize power consumption of the second branch. Optionally, the processing module 131 may indicate the second control circuit 133 to adjust the impedance of the first branch to minimum impedance, so as to minimize power consumption of the first branch.

In this case, the charging management circuit 110 may be configured to: generate the system voltage based on the charging voltage received by the Vbus terminal, output the system voltage at the Vsys terminal to supply power to the power consumption circuit 120, generate a voltage for charging the battery pack based on the charging voltage received by the Vbus terminal, and output the voltage at the Vbat terminal to charge the first battery bat1 and the second battery bat2.

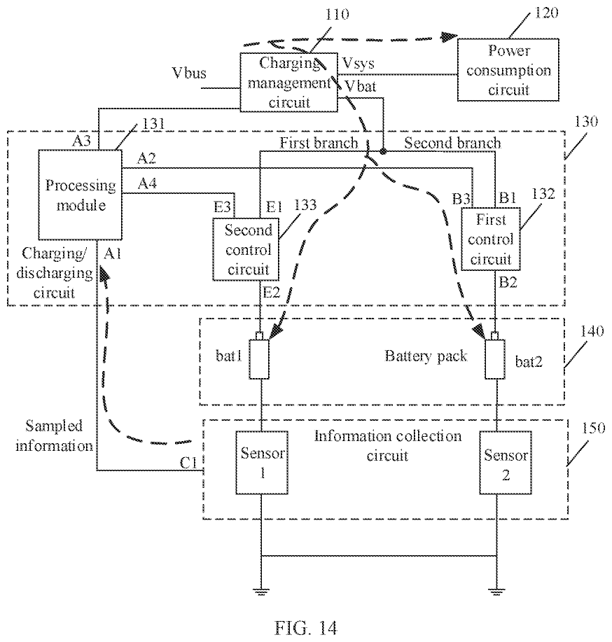

In this case, as shown in FIG. 14, the charging voltage received by the Vbus terminal of the charging management circuit 110 is used to supply power to the power consumption circuit 120 through the Vsys terminal; and the charging voltage received by the Vbus terminal of the charging management circuit 110 is used to charge the first battery batt and the second battery bat2 through the Vbat terminal.

In a process of charging the first battery bat1 and the second battery bat2, the processing module 131 may be specifically configured to:
when I1−I2>Ith_charge, indicate the first control circuit 132 to reduce the impedance of the second branch, and/or indicate the second control circuit 133 to increase the impedance of the first branch; or when I2−I1>Ith_charge, indicate the first control circuit 132 to increase the impedance of the second branch, and; or indicate the second control circuit 133 to decrease the impedance of the first branch; or when I1−I2>Ith_charge, indicate the first control circuit 132 to keep the impedance of the second branch unchanged, and indicate the second control circuit 133 to keep the impedance of the first branch unchanged.

Vth_open represents a preset threshold of the voltage difference, and Ith_charge and Ith_balance each represents a preset threshold of a current difference. A specific value of the threshold is not limited in this embodiment of this application. Values of Ith_charge and Ith_balance may be the same or different.

Optionally, to reduce power consumption of the first branch and the second branch, when I1−I2>Ith_charge, the processing module 131 may preferentially reduce the impedance of the second branch until the impedance of the second branch decreases to the minimum impedance; or when I2−I1>Ith_charge, the processing module 131 may preferentially reduce the impedance of the first branch until the impedance of the first branch decreases to the minimum impedance.

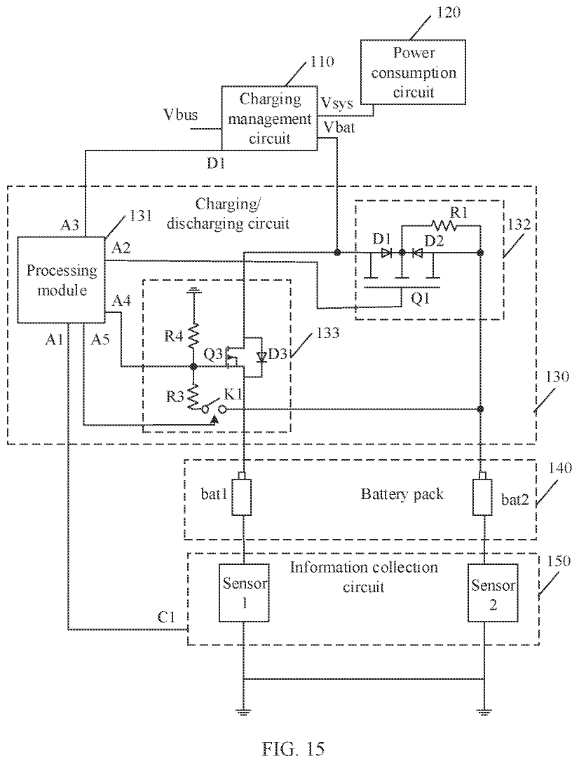

For example, implementation structures of the first control circuit 132 and the second control circuit 133 in the charging/discharging circuit in the scenario shown in FIG. 9 are described in the following with reference to FIG. 15 to FIG. 19.

In the charging/discharging circuit shown in FIG. 15 to FIG. 19, for the implementation structure of the first control circuit 132, refer to an example shown in FIG. 7A to FIG. 8B. Details are not described herein again.

As shown in FIG. 15, the second control circuit 133 may include a PMOS transistor Q3. A drain of the PMOS transistor Q3 is used as the E1 end of the second control circuit 133, a source thereof is used as the E2 end of the second control circuit 133, and a gate thereof is used as the E3 end of the second control circuit 133. A diode D3 is a body diode of the PMOS transistor Q3.

The processing module 131 may output direct current voltage signals of different voltage values through the A4 end, to control the PMOS transistor Q3 to be disconnected, in a linear interval, or completely connected.

When the processing module 131 controls the PMOS transistor to be in the linear interval, if the voltage signal output by the processing module 131 through the A4 end is enhanced, impedance of the PMOS transistor Q3 is increased, and the impedance of the first branch is increased; or if the voltage signal output by the processing module 131 through the A1 end is weakened, the impedance of the PMOS transistor Q3 is decreased, and the impedance of the first branch is decreased.

Optionally, when the electronic device is not powered on, to ensure that the electronic device can be powered on normally, the first branch is connected, so that the battery 1 can supply power to the power consumption circuit. As shown in FIG. 15, the second control circuit 133 may further include a resistor R3, a resistor R4, and a switch K1. A first end of the switch K1 is connected to the positive electrode of the second battery bat2, a second end thereof is grounded through the resistor R3 and the resistor R4 that are connected in series, and a control end of the switch K1 is connected to an A5 end of the processing module 131. One end connected to the resistor R3 and the resistor R4 is connected to the gate of the PMOS transistor Q3. The switch K1 is a switch that is turned on when the voltage of the control end is 0, and is turned off when the voltage of the control end is not 0. In this case:

When the electronic device is not powered on, to ensure that the electronic device is powered on normally, the switch K1 is turned on, a voltage of the second battery bat2 is divided by the resistor R3 and the resistor R4, an obtained divided voltage is output to the gate of the PMOS transistor Q3, the PHOS transistor Q3 is connected, the first branch is in a connected state, and the first battery bat1 can supply power to the power consumption circuit 120 through the first branch and the charging management circuit 110. After the electronic device is powered on, the processing module 131 may output a voltage to the control end of the switch K1, to control the switch K1 to turn off. Correspondingly, the PMOS transistor Q3 is controlled by the voltage signal output through the A4 end of the processing module 131.

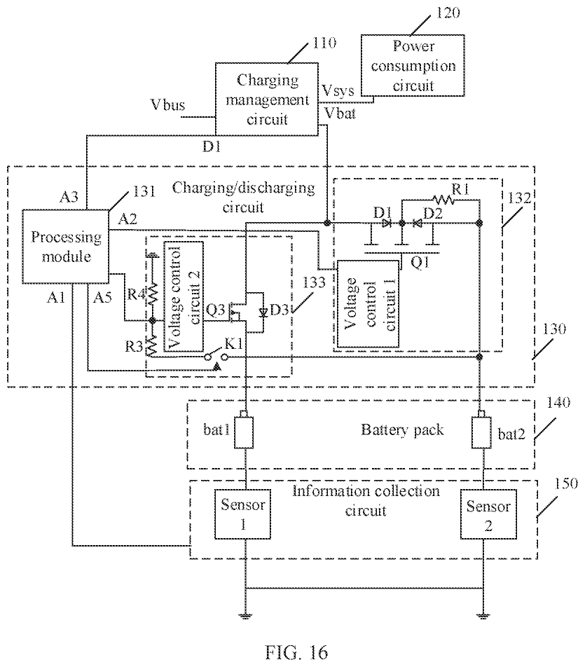

In FIG. 15, the control signal output by the processing module 131 through the A4 end is the direct current voltage signal. Optionally, the control signal output by the processing module 131 through the A4 end may be a PWM signal. In this case, as shown in FIG. 16, a voltage control circuit 2 is added between the connection end of the resistor R3 and the resistor R4 and the gate of the PMOS transistor Q3, to convert the PWM signal into the direct current voltage signal. Correspondingly, the processing module 131 may adjust, by using a duty cycle of the PWM a voltage value of a voltage signal output by the voltage control circuit 2, to control the PMOS transistor Q3 to be completely connected, disconnected, or in the linear interval. The processing module 131 may further control, by adjusting the duty cycle of the PWM signal, the voltage value of the voltage signal output by the voltage control circuit 1 to increase or decrease, to increase or decrease the impedance of the PMOS transistor when the PMOS transistor Q3 is in the linear interval.

Optionally, the switch K1 in the second control circuit 133 in FIG. 16 may be omitted. In this case, the PWM signal output through the A4 end of the processing module 131 may be used to adjust a voltage value of a voltage division signal (which is obtained by dividing the voltage of the second battery bat2 by the resistor R3 and the resistor R4). Correspondingly, the processing module 131 may adjust, by using a duty cycle of the PWM signal, a voltage value of a voltage signal output by the voltage control circuit 2, to control the PMOS transistor Q3 to be completely connected, disconnected, or in the linear interval. The processing module 131 may further control, by adjusting the duty cycle of the PWM signal, the voltage value of the voltage signal output by the voltage control circuit 2 to increase or decrease, to increase or decrease the impedance of the PMOS transistor when the PMOS transistor Q3 is in the linear interval.

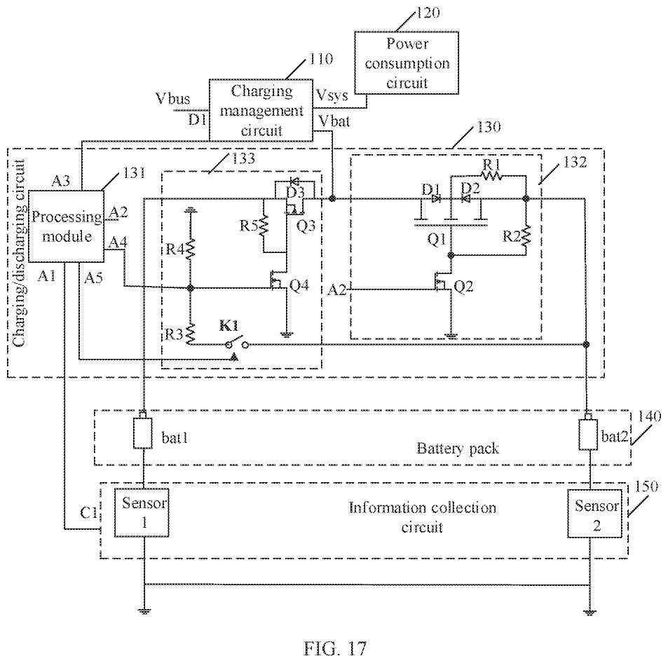

A difference between the second control circuit 133 of the charging/discharging circuit shown in FIG. 17 and the second control circuit 133 shown in FIG. 15 is that a resistor R5 and an NMOS transistor Q4 are added to the second control circuit 133 in FIG. 17. The gate of the PMOS transistor Q3 is connected to a drain of the NMOS transistor Q4. A source of the NMOS transistor Q4 is grounded, and a gate thereof is connected to the A4 end of the processing module 131. Both ends of the resistor R5 are respectively connected to the gate and the source of the PMOS transistor Q3.

In this circuit structure, when the NMOS transistor Q4 is disconnected, a gate voltage of the PMOS transistor Q3 is 0, and the PMOS transistor Q3 is disconnected. When the NMOS transistor Q4 is completely connected or in a linear interval, impedance of the resistor R5 and impedance of the NMOS transistor Q4 divide a voltage of the first battery bat1, and the gate of the PMOS transistor Q3 receives a divided voltage. A change of the impedance of the NMOS transistor Q4 causes a change of the gate voltage of the PMOS transistor Q3; that is, the divided voltage received by the gate of the PMOS transistor Q3 changes, to control the PMOS transistor Q3 to be completely connected or in the linear interval. In addition, when the PMOS transistor Q3 is in the linear interval, a change of the divided voltage may cause the change of the impedance change of the PMOS transistor Q3, and further cause a change of the impedance of the first branch. When the PMOS transistor Q3 is completely connected, the PMOS transistor Q3 has minimum impedance, and the first branch has minimum impedance.

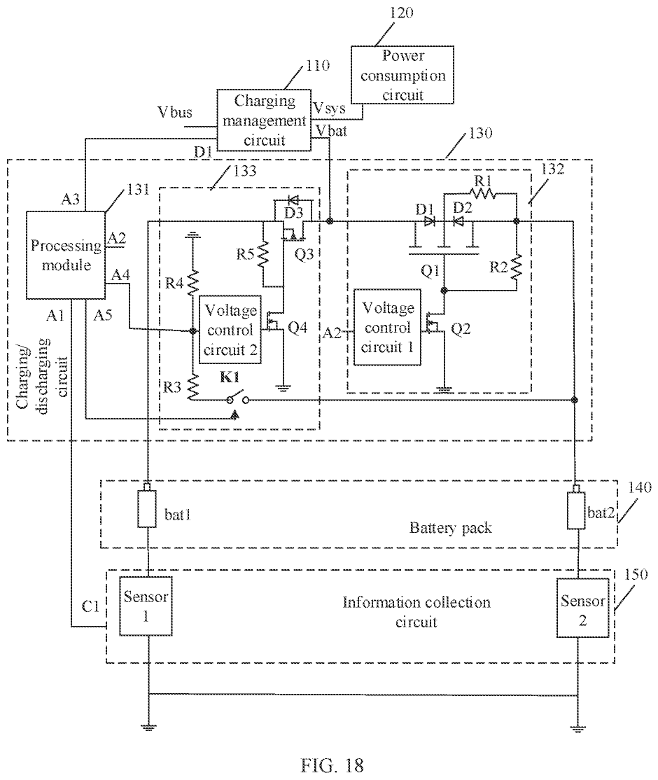

Optionally, the control signal output through the A4 end of the processing module 131 may be a PWM signal. In this case, as shown in FIG. 18, a voltage control circuit 2 may be disposed between one end connected to the resistor R3 and the resistor R4 and the gate of the NMOS transistor Q4. The voltage control circuit 2 is configured to convert the PWM signal into a direct current voltage signal, to control the NMOS transistor Q4 by using the direct current voltage signal. For a specific control principle, refer to the foregoing description. Details are not described herein again.

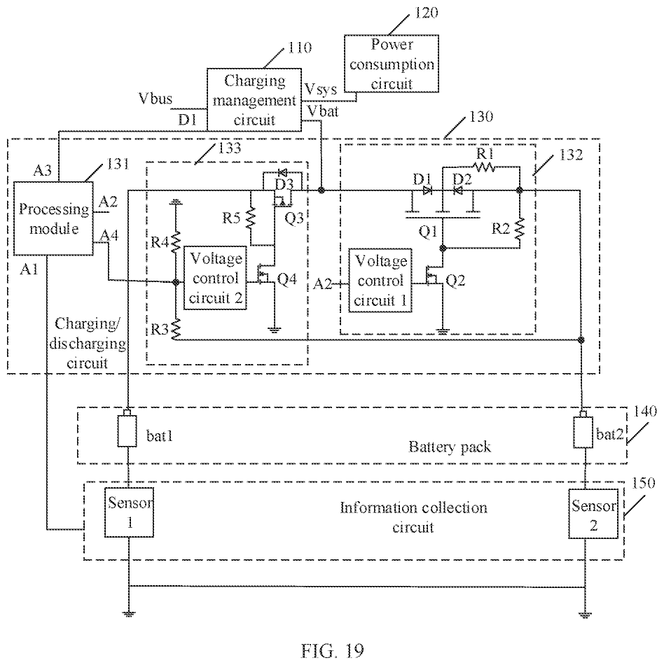

Optionally, as shown in FIG. 19, the switch K1 of the second control circuit in the charging/discharging circuit shown in FIG. 18 may be omitted. For a reason, refer to corresponding descriptions in FIG. 15. Details are not described herein again.

It should be noted that the charging/discharging circuit shown in FIG. 15 to FIG. 19 is merely schematic. Different implementation structures of the first control circuit 132 and the second control circuit 133 may be combined to form the charging/discharging circuit in the embodiments of this application. FIG. 15 to FIG. 19 show only example structures of possible implementations of the charging/discharging circuit, and other possible implementation structures are not listed one by one herein.

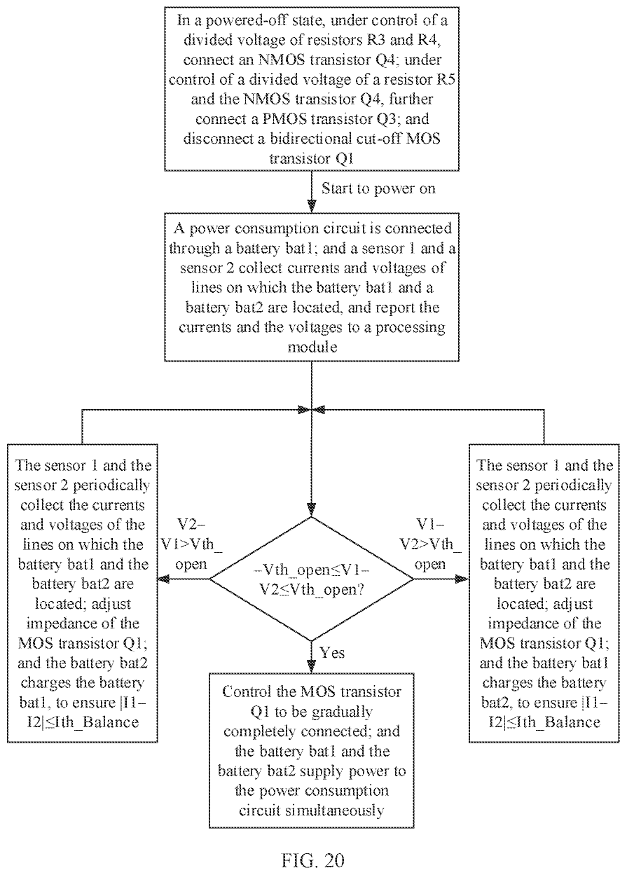

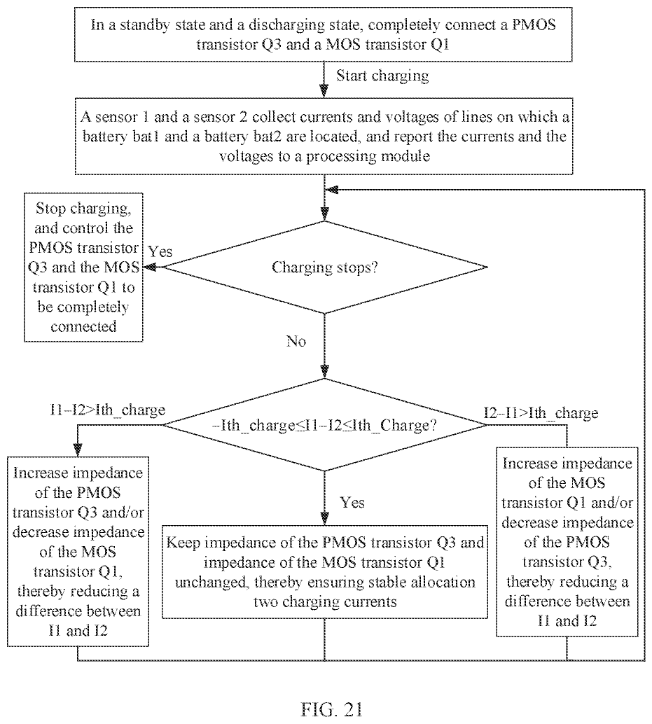

The charging/discharging circuit shown in FIG. 19 is used as an example to describe an operating principle of a specific implementation structure of the charging/discharging circuit with reference to FIG. 20 and FIG. 21.

A flowchart shown in FIG. 20 shows an operating principle of a charging/discharging circuit from power-off to power-on of an electronic device. Specifically:

When the electronic device is powered off, the resistor R3 and the resistor R4 divide the voltage of the second battery bait to obtain a divided voltage, to control NMOS transistor Q4 to be connected; and then the resistor R5 and the NMOS transistor Q4 divide the voltage of the first battery bat1 to obtain a divided voltage, to control PMOS transistor Q3 to be connected, so that the first branch is connected. Because the electronic device is not powered on, the gate of the NMOS transistor Q2 is disconnected, and the bidirectional cut-off MOS transistor Q1 is further disconnected.

After the electronic device starts to power on, the first battery bat1 supplies power to the power consumption circuit through the charging management circuit on the first branch. When the electronic device is successfully powered on, the sensor 1 and the sensor 2 respectively correspondingly collect currents and voltages of lines on which the first battery bat′ and the second battery batt are located, and report the currents and the voltages to the processing module 131.

The processing module 131 determines a magnitude relationship between the first voltage V1 and the second voltage V2. If −Vth_open≤V1−V2≤Vth_open, the processing module 131 controls the NMOS transistor Q2 to be connected by outputting a gradually enhanced voltage signal, so as to control the bidirectional cut-off MOS transistor Q1 to be completely connected gradually, where the first battery batt and the second battery bat2 supply power to the power consumption circuit simultaneously. If V2−V1>Vth_open, the sensor 1 and the sensor 2 periodically collect currents and voltages of the lines on which the first battery bat1 and the second battery bat2 are located, and the processing module 131 adjusts the impedance of the bidirectional cut-off diode Q1 based on the first current and the second current, to ensure |I1−I2|≤Ith_Balance in a process in which the second battery bat1 charges the first battery bat2. If V1−V2>Vth_open, the sensor 1 and the sensor 2 periodically collect the currents and the voltages of the lines on which the first battery bat1 and the second battery bat2 are located, and the processing module 131 adjusts the impedance of the bidirectional cut-off diode Q1 based on the first current and the second current, to ensure |I1−I2≤Ith_Balance in a process in which the second battery bat2 charges the first battery bat1.

A flowchart shown in FIG. 21 shows an operating principle of a charging/discharging circuit for charging a first battery bat1 and a second battery bat2 when an electronic device is in a standby state or a discharging state. Specifically:

In the standby state or the discharging state, the processing module 131 controls the PMOS transistor Q3 and the MOS transistor Q1 to be completely connected.

If the electronic device starts charging, the sensor 1 and the sensor 2 respectively correspondingly collect currents of lines on which the first battery bat1 and the second battery bat2 are located, and report the currents to the processing module 131.

The processing module 131 determines whether the charging stops.

If yes, the charging mode is exited, to control the PMOS transistor Q3 and the MOS transistor Q1 to be completely connected, and this branch ends.

If no, the processing module 131 determines a magnitude relationship between the first current I1 and the second current I2. If −Ith_charge≤I1−I2≤Ith_Charge, the processing module 131 keeps the impedance of the PMOS transistor Q3 and the impedance of the MOS transistor Q1 unchanged, so as to ensure stable allocation of charging currents of the lines on which the first battery and the second battery are located. If I1−I2>Ith_charge, the processing module 131 increases the impedance of the PMOS transistor Q3, and/or decreases the impedance of the MOS transistor Q1, so as to reduce the difference between I1 and I2. If I2−I1>Ith_charge, the processing module 131 reduces the impedance of the PMOS transistor Q3, and/or increases the impedance of the MOS transistor Q1, so as to reduce the difference between I1 and I2.

Then, the processing module 131 returns to re-determine whether charging stops. This process repeats until the charging stops.

It should be noted that, in the foregoing embodiment, that the first battery bat1 and the second battery bat2 are simultaneously charged is used as an example. In actual application, the processing module 131 may separately select to charge one of the batteries by controlling connection/disconnection of the first branch and connection/disconnection of the second branch.

It should be noted that the processing module may separately determine an operating status of each battery in the battery pack based on the collected voltage and/or current, and when it is detected that an operating status of a battery is abnormal, control a charging/discharging line of the corresponding battery to be disconnected. Optionally, the processing module may further report alarm information of abnormal battery operation to an upper-layer system, so as to improve user experience.

It should be noted that, in the foregoing embodiments, that the battery pack includes two batteries, and the charging/discharging circuit includes two branches is used as an example. In actual application, the battery pack may include more than two batteries. In this case, for a charging/discharging branch of another battery, reference may be made to a charging/discharging branch (namely, a branch formed by the second branch, the second battery, and the sensor 2) corresponding to the second battery.

This application further provides an electronic device, including the circuit shown in any one of the foregoing embodiments.

In embodiments of this application, “at least one” means one or more, and “a plurality of” means two or more. The term “and/or” describes an association relationship of associated objects, and indicates that three relationships may exist. For example, A and/or B may indicate the following cases: Only A exists, both A and B exist, and only B exists, where A and B may be singular or plural. The character “/” usually indicates an “or” relationship between the associated objects. “At least one of the following” or a similar expression thereof indicates any combination of the following, and includes any combination of one or more of the following. For example, at least one of a, b, or c may indicate a, b, c, a and b, a and c, b and c, or a and c, where a, b, and c may indicate a singular or plural form.

A person of ordinary skill in the art may be aware that the units and algorithm steps described in embodiments disclosed in this specification can be implemented by electronic hardware or a combination of computer software and electronic hardware. Whether these functions are implemented by using hardware or software depends on specific application of the technical solution and design constraints. A person skilled in the art may use different methods to implement the described functions for each particular application, but it should not be considered that the implementation goes beyond the scope of this application.

A person skilled in the art can clearly understand that, for convenience and brevity of description, reference may be made to corresponding processes in the method embodiments for specific operating processes of the foregoing system, apparatus, and unit. Details are not described herein again.

In several embodiments provided in this application, if any function is implemented in the form of a software functional unit and sold or used as an independent product, the function may be stored in a computer readable storage medium. Based on such an understanding, the technical solutions of this application essentially, or the part contributing to the prior art, or some of the technical solutions may be implemented in a form of a software product. The software product is stored in a storage medium, and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (Read-Only Memory, hereinafter referred to as ROM), a random access memory (Random Access Memory, hereinafter referred to as RAM), a magnetic disk, or an optical disc.

The foregoing descriptions are merely specific implementations of this application. Any person skilled in the art can easily figure out modifications or replacements within the technical scope of this application, and these modifications or replacements shall fall within the protection scope of this application. The protection scope of this application shall be subject to the protection scope of the claims.

1. A charging/discharging circuit, configured to charge/discharge a battery pack, wherein the battery pack comprises a first battery and a second battery, the charging/discharging circuit comprising:
a first branch, comprising:
a first end configured to be connected to a voltage supply end; and
a second end configured to be connected to the first battery, wherein a voltage provided by the voltage supply end is configured to charge the first battery through the first branch;
a second branch, comprising:
a first end configured to be connected to the voltage supply end;
a second end configured to be connected to the second battery, wherein the voltage provided by the voltage supply end is configured to charge the second battery through the second branch; and
a first control circuit configured to adjust an impedance of the second branch; and
a processing module configured to:
obtain a first current of the first branch and a second current of the second branch; and
provide an indication, based on the first current and the second current, to the first control circuit to adjust the impedance of the second branch, so as to balance the first current and the second current.

2. The charging/discharging circuit of claim 1, further comprising a charging management circuit, wherein a first end of the charging management circuit is the voltage supply end, and wherein the processing module is further configured to:
obtain a first voltage of the first branch and a second voltage of the second branch; and
control the first end of the charging management circuit to provide a voltage when a difference between the first voltage and the second voltage is not greater than a preset first threshold, if it is detected that the second end of the first branch receives a charging voltage.

3. The charging/discharging circuit of claim 2, wherein the processing module is further configured to control the first end of the charging management circuit not to output the voltage when the difference between the first voltage and the second voltage is greater than the preset first threshold, if it is detected that the second end of the first branch receives the charging voltage.

4. The charging/discharging circuit of claim 3, wherein the processing module is further configured to provide the indication to the first control circuit to adjust the impedance of the second branch when the difference between the first voltage and the second voltage is greater than the preset first threshold.

5. The charging/discharging circuit of claim 1, wherein the first branch comprises a second control circuit that is configured to adjust impedance of the second branch, and wherein the processing module is further configured to provide an indication, based on the first current and the second current, to the second control circuit to adjust the impedance of the first branch, so as to balance the first current and the second current.

6. The charging/discharging circuit of claim 5, wherein when the first current is lower than the second current, and a difference between the first current and the second current is greater than a preset second threshold, the processing module is configured to:
either a) provide an indication to the second control circuit to reduce the impedance of the first branch if it is determined that the impedance of the first branch is greater than a minimum impedance; or
b) provide an indication to the first control circuit to increase the impedance of the second branch if it is determined that the impedance of the first branch is the minimum impedance.

7. The charging/discharging circuit of claim 5, wherein when the first current is greater than the second current, and a difference between the first current and the second current is greater than a preset second threshold, the processing module is configured to:
either a) provide an indication to the first control circuit to reduce the impedance of the second branch if it is determined that the impedance of the second branch is greater than a minimum impedance; or
b) provide an indication to the second control circuit to increase the impedance of the first branch if it is determined that the impedance of the second branch is the minimum impedance.

8. The charging/discharging circuit of claim 5, wherein
the second control circuit is further configured to control the first branch to be in a connected state when an electronic device comprising the battery pack is in a powered-off state.

9. The charging/discharging circuit of claim 8, wherein the first control circuit is further configured to control the second branch to be in a disconnected state when the electronic device is in the powered-off state.

10. The charging/discharging circuit of claim 5, wherein when the first battery and the second battery discharge, the processing module is further configured to provide an indication to the first control circuit to adjust the impedance of the second branch to a minimum impedance, and provide an indication to the second control circuit to adjust the impedance of the first branch to the minimum impedance.

11. The charging/discharging circuit of claim 1, wherein the first control circuit comprises a first switching transistor with a linear interval, wherein a first end and a second end of the first switching transistor are respectively the first end and the second end of the second branch, and a control end of the first switching transistor is connected to the processing module, and wherein the processing module is configured to send a control signal to the control end of the first switching transistor, to control an impedance and a connection state of the first switching transistor.

12. The charging/discharging circuit of claim 1, wherein the first control circuit comprises a second switching transistor with a linear interval, a third switching transistor with a linear interval, and a first resistor, wherein a first end and a second end of the second switching transistor are respectively the first end and the second end of the second branch, a control end of the second switching transistor is grounded through the third switching transistor, a control end of the third switching transistor is connected to the processing module, and the second end of the second switching transistor is connected to the control end of the second switching transistor through the first resistor, and wherein the processing module is configured to send a control signal to the control end of the third switching transistor, to control an impedance and a connection state of the third switching transistor.

13. The charging/discharging circuit of claim 12, wherein the control signal sent by the processing module is a pulse-width modulation (PWM) signal, and the first control circuit further comprises a first voltage control circuit, wherein the control end of the third switching transistor being connected to the processing module comprises the control end of the third switching transistor being connected to the processing module through the first voltage control circuit, and wherein the first voltage control circuit is configured to convert the PWM signal sent by the processing module into a direct current control signal, and send the converted direct current control signal to the control end of the third switching transistor.

14. The charging/discharging circuit of claim 1, wherein the second control circuit comprises a fourth switching transistor with a linear interval, wherein a first end and a second end of the fourth switching transistor are respectively the first end and the second end of the first branch, and a control end of the fourth switching transistor is connected to the processing module, and wherein the processing module is configured to send a control signal to the control end of the fourth switching transistor, to control an impedance and a connection state of the fourth switching transistor.

15. The charging/discharging circuit of claim 1, wherein the second control circuit comprises a fifth switching transistor with a linear interval, a sixth switching transistor with a linear interval, and a second resistor, wherein a first end and a second end of the fifth switching transistor are respectively the first end and the second end of the first branch, a control end of the fifth switching transistor is grounded through the sixth switching transistor, a control end of the sixth switching transistor is connected to the processing module, and the second end of the fifth switching transistor is connected to the control end of the fifth switching transistor through the second resistor, and wherein the processing module is configured to send a control signal to the control end of the sixth switching transistor, to control an impedance and a connection state of the sixth switching transistor.

16. The charging/discharging circuit of claim 15, wherein the control signal sent by the processing module is a pulse-width modulation (PWM) signal, and the second control circuit further comprises a second voltage control circuit, wherein the control end of the sixth switching transistor being connected to the processing module comprises the control end of the sixth switching transistor being connected to the processing module through the second voltage control circuit, and wherein the second voltage control circuit is configured to convert the control signal sent by the processing module into a direct current voltage signal, and send the converted direct current control signal to the control end of the third switching transistor.

17. The charging/discharging circuit of claim 1, further comprising a collection circuit connected to both the battery pack and the processing module, wherein the collection circuit is configured to collect currents and/or voltages of the first branch and the second branch, and send the collected currents and/or voltages to the processing module, and wherein the processing module is further configured to receive the currents and/or voltages.

18. An electronic device, comprising:
a battery pack comprising a first battery and a second battery; and
a charging/discharging circuit configured to charge/discharge the battery pack, the charging/discharging circuit comprising,
a first branch, comprising:
a first end configured to be connected to a voltage supply end; and
a second end configured to be connected to the first battery, wherein a voltage provided by the voltage supply end is configured to charge the first battery through the first branch;
a second branch, comprising:
a first end configured to be connected to the voltage supply end;
a second end configured to be connected to the second battery, wherein the voltage provided by the voltage supply end is configured to charge the second battery through the second branch; and
a first control circuit configured to adjust an impedance of the second branch; and
a processing module configured to:
obtain a first current of the first branch and a second current of the second branch; and
provide an indication, based on the first current and the second current, to the first control circuit to adjust the impedance of the second branch, so as to balance the first current and the second current.

19. The electronic device of claim 18, wherein the charging/discharging circuit further comprises a charging management circuit, wherein a first end of the charging management circuit is the voltage supply end, and wherein the processing module is further configured to:
obtain a first voltage of the first branch and a second voltage of the second branch; and
control the first end of the charging management circuit to provide a voltage when a difference between the first voltage and the second voltage is not greater than a preset first threshold, if it is detected that the second end of the first branch receives a charging voltage.

20. The electronic device of claim 19, wherein the processing module is further configured to control the first end of the charging management circuit not to output the voltage when the difference between the first voltage and the second voltage is greater than the preset first threshold, if it is detected that the second end of the first branch receives the charging voltage.
